(19) United States
(12) Patent Application Publication
(10) Pub. No.: US 2013/0228692 A1
(43) Pub. Date: Sep. 5, 2013

(54) FLAME DETECTOR WITH OPTICS ARRAY

(71) Applicant: Christopher Scott Larsen, Rockford, MN (US)

(72) Inventor: Christopher Scott Larsen, Rockford, MN (US)

(73) Assignee: Honeywell International Inc., Morristown, NJ (US)

(21) Appl. No.: 13/412,531

(22) Filed: Mar. 5, 2012

(51) Int. Cl. G01J 5/10; G01J 5/02

(52) U.S. Cl. 250/342; 250/349

(57) ABSTRACT

A system includes a micro-optic array of pixel elements positioned to receive radiation from a flame. A mid-wave infrared (MWIR) detector is positioned to receive mid-wave infrared radiation from the micro-optic array. A filter is provided to pass mid-wave infrared radiation to the MWIR detector. A controller is provided to sequentially select different sets of pixel elements of the micro-optic array to provide mid-wave infrared radiation to the MWIR detector representative of the flame.

### BACKGROUND

Industrial flame detection is used to detect and suppress flames automatically in high value installations prone to fires (e.g. oil platforms). Detection of intentional flares from flarestacks is another important use of flame detection. Many flame detection technologies present false alarm issues due to the difficulty of determining flame from non-imaging single detectors. Prior image detection systems utilized mid-wave infrared spectrum signals to detect flames and reduce false alarms. The image detection is based around a mid-wave infrared bolometer array to build images for use by image detection algorithms.

### SUMMARY

A flame detector includes a micro-optic array positioned to receive radiation from a flame, a mid-wave infrared (MWIR) detector, such as a bolometer pixel positioned to receive mid-wave infrared radiation from the micro-optic array, a filter to pass mid-wave infrared radiation, and a controller to sequentially select different sets of pixels of the micro-optic array to provide mid-wave infrared radiation to the MWIR detector representative of the flame and provide an indication of the presence of the flame.

A system includes a micro-optic array of pixel elements positioned to receive radiation from a flame. A MWIR detector is positioned to receive mid-wave infrared radiation from the micro-optic array. A filter is provided to pass mid-wave infrared radiation to the MWIR detector. A controller is provided to sequentially select different sets of pixel elements of the micro-optic array to provide mid-wave infrared radiation to the MWIR detector representative of the flame.

A method includes receiving infrared radiation from a flame at a micro-optic array of pixel elements, positioning a MWIR detector to receive mid-wave infrared radiation from the micro-optic array, filtering the received infrared radiation to pass mid-wave infrared radiation, and sequentially selecting different sets of pixel elements of the micro-optic array to provide radiation to the MWIR detector representative of the flame.

### BRIEF DESCRIPTION OF THE DRAWINGS

FIG. 1 is a block schematic diagram of a flame detection system with single pixel imaging according to an example embodiment.

FIG. 2 is a ray diagram illustrating operation of a minor array according to an example embodiment.

FIG. 3 is a block schematic and ray diagram illustrating operation of an optics array with a single pixel detector according to an example embodiment.

FIG. 4 is a block diagram of a computer system for performing algorithms according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

Bolometer arrays are used in flame detection systems. The use of such arrays can reduce the number of false alarms. However, arrays of bolometer pixels can be very expensive to build.

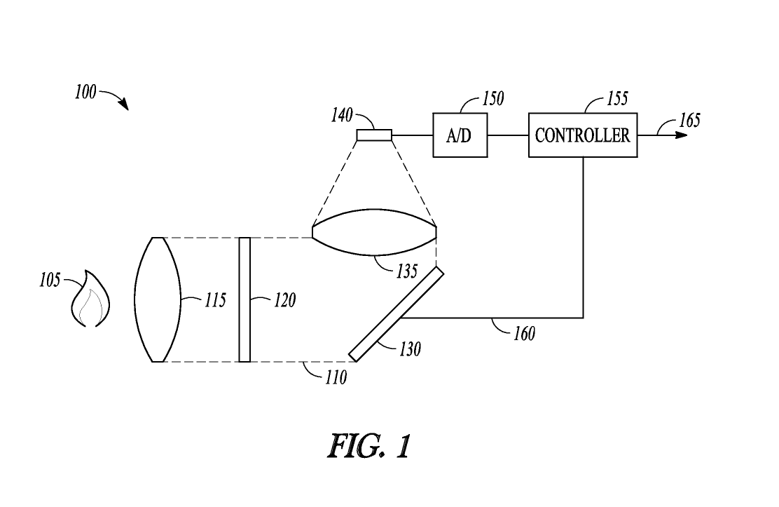

FIG. 1 is a block diagram of a system 100 for sensing flames. A flame is shown at 105 and is within a field of view of a sensor 110. Sensor 110 receives infrared radiation from the flame 105 at optics 115. In one embodiment, a filter 120 is positioned in the path of the radiation in sensor 110. The filter may aid in selecting a desired wavelength of light to be passed to an optical element array, such as a micro-minor array 130. In one embodiment, mid-wave infrared radiation is passed to the micro-mirror array 130. In further embodiments, the filter 120 may be positioned in the path of radiation after it has been reflected by the micro-mirror array. In still further embodiments, no filter is used.

A selected subset of mirrors is positioned to reflect received radiation through further optics 135 toward a detector 140. In one embodiment, the detector is formed of a single infrared pixel that receives an aggregate intensity of infrared radiation in a desired bandwidth from the set of selected mirrors. The detector 140 provides an output representative of the aggregate intensity of infrared radiation to an analog to digital converter 150, which converts the aggregate intensity to a digital data output. A controller 155 receives the digital output. Controller 155 includes a processor to process received data. Optics 135 may also contain a filter to select a desired wavelength of infrared radiation to pass to the detector. In some embodiments, the detector 140 may be selected to provide an adequate level of filtering to detect desired types of flames, without using a filter.

Controller 155 may also be used to control the micro-minor array 130 via line 160 to select the mirrors' positions to reflect the received radiation toward the detector 140. In one embodiment, the controller sequentially positions different sets of minors of the micro-mirror array to provide a sequential series of aggregated radiation to the detector 140. The mirrors in each set may be randomly selected in one embodiment. In further embodiments, predetermined sets of minors may be used, or mirrors may be selected in accordance with a different algorithm.

The sequential series of data derived from the sets is then used by the controller 155, along with knowledge of the minors in the sets corresponding multiple sequential sparse pixel sets to detect whether or not a flame is present. The data may be suitable to build at least one image, or a video from a sequence of images of the source of flame, or may be processed without converting it to an image to detect the presence of the flame and provide an output on a line 165.

In one embodiment, micro-minor array 130 may be a commercially available array, such as a Texas Instrument DLP1700. The optics illustrated are in a simplified form, and each may include multiple lenses, such as chalcogenide lenses for a wide field of view.

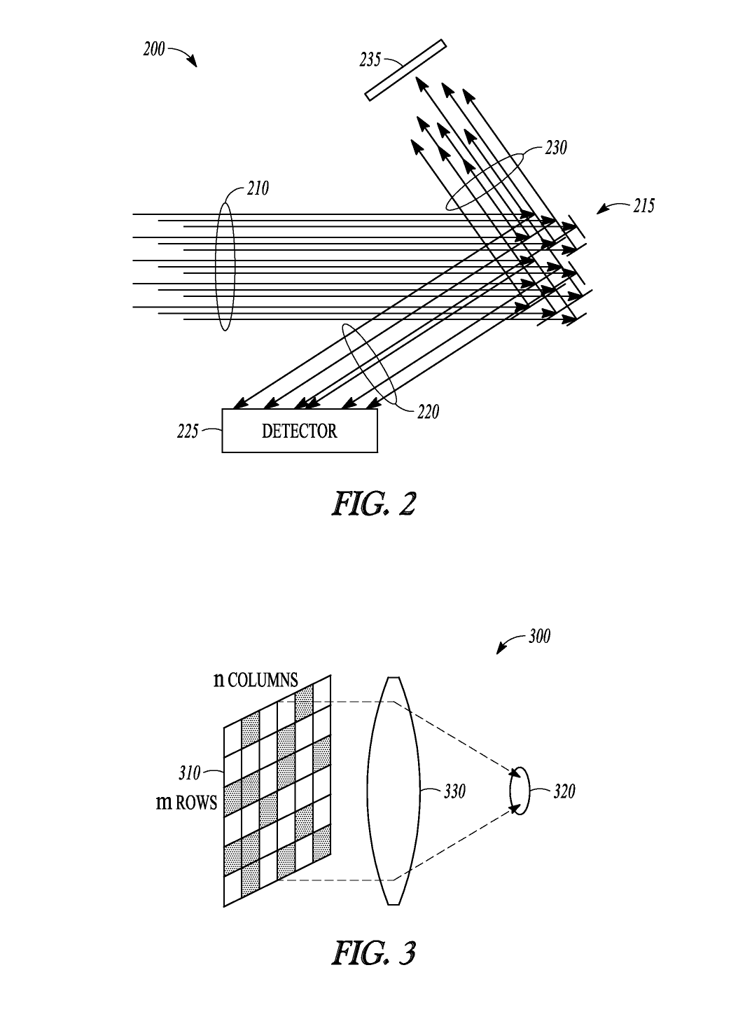

FIG. 2 is a ray diagram 200 illustrating radiation by radiation lines 210 impinging on mirrors of a micro-mirror array 215. A set of mirrors is positioned is positioned to reflect some of the radiation as indicated by lines 220 toward a detector 225. As mentioned above, the detector in one embodiment is a single pixel infrared detector that aggregates the radiation 220 from the set of minors. Also illustrated is radiation 230 that is reflected away from the detector 225. In one embodiment, radiation 230 may be directed toward a photo detector 235 to detect visible light corresponding to a set of minors that reflects the radiation toward it. The photo detector may be an array of photo detectors, or a single photo detector to aggregate the light reflected toward it. The aggregated light may be processed in the same manner as the data corresponding to the single pixel infrared detector in various embodiments. In further embodiments, the detector 235 may be an infrared detector to detect a different wavelength of light than detector 225. In still further embodiments, the detector 235 may detect the same wavelength of light as detector 225, providing two sets of data for detecting the flame.

FIG. 3 is a schematic block diagram 300 representing selected minors in an optics array 310. In this embodiment, an array of n by m optical elements is illustrated. In various embodiments, the size of the array may vary from 10×10 for a very coarse image up to 1920×1080 for high definition images. This range is merely an example, and sizes may vary even further as technology permits. The elements may be mirrors in one embodiment that are operable to either reflect light toward a single pixel detector 320 through optics 330 or away from the single pixel detector 320. The array 310 effectively operates as a pixel array, with the minors corresponding to corresponding pixels from the image that is focused on the array. In further embodiments, such as that illustrated in FIG. 3, the micro-optic array is a selectively transmissive pixel array. The sets of pixels to be focused on the single pixel of the detector are transmissive to the radiation, whereas unselected pixels are opaque. In some embodiments, up to half of the pixels in the array may be used to provide radiation to the detector. A few more than half, or less than half may be used in further embodiments, so long as the resulting data produced is suitable for detecting a flame.

Since a single pixel is used to provide aggregate measurements of the radiation provided by successive sets of mirrors, the controller 155 may process the data to determine whether or not a flame is present. In one embodiment, controller 155 may find the image by performing the following calculations.

Let p_{i,j,k}=pixel in row i, column j on (1), off (0) during sample k. Let x_{i,j,k}=image light intensity in row i, column j during sample k. Let yₖ=total intensity of the k^{th} sample recorded by the detector. Then,

$${y}_{k} = {\sum }_{j = 1}^{n} {\sum }_{i = 1}^{m} ( {p}_{i , j , k} ) ( {x}_{i , j , k} )$$

Or, [yₖ]=[p_{i,j,k}]·[x_{i,j,k}]. Solve for [x_{i,j}], which is the image.

The frame rate may be dependent on the time constant of the sensor in some embodiments. A sensor with a 1 ms 63% time constant has about 3 ms 95% time constant. The frame rate for various qualities of flame detection may be determined utilizing classic sampling theory.

Let pixel count=c. Let sensor 95% time constant=t. Let Nyquist divider=N, which is representative of how many fewer samples than if each pixel were sampled individually.

Then: frame rate=f=N/(c*t). For t=3 ms, N=50, and c=120×120=14400, f=1.16 Hz. For t=6 us, N=50, and c=14400, f=578 Hz.

Samples may be taken during every time constant. If sliding window of the last N samples is used, frame rate may only be limited by calculation speed. There is a significant amount of computation that takes place in a fairly short amount of time.

If pixel count is c, at least c²/N calculations per frame are performed. For a frame rate of f, the required calculation speed is fc²/N. For c=120×120=14400, f=30 Hz, and N=50, this is 0.12E8 calculations/second. For c=120×120=14400, f=30 Hz, and N=5, this is 1.2E8 calculations/second.

As more samples are taken, image quality increases along with the cost of components that can handle the associated computations. In one embodiment, N may be selectable via software to allow users to make tradeoffs in image quality.

In one embodiment, the whole array is turned on to detect if there is any mid-wave infrared radiation in the FOV. If there is not, the array doesn't need to bother constructing an image of the mid-wave infrared image, because there is no image to detect. If some radiation is detected, the array may be used as described above to detect a flame.

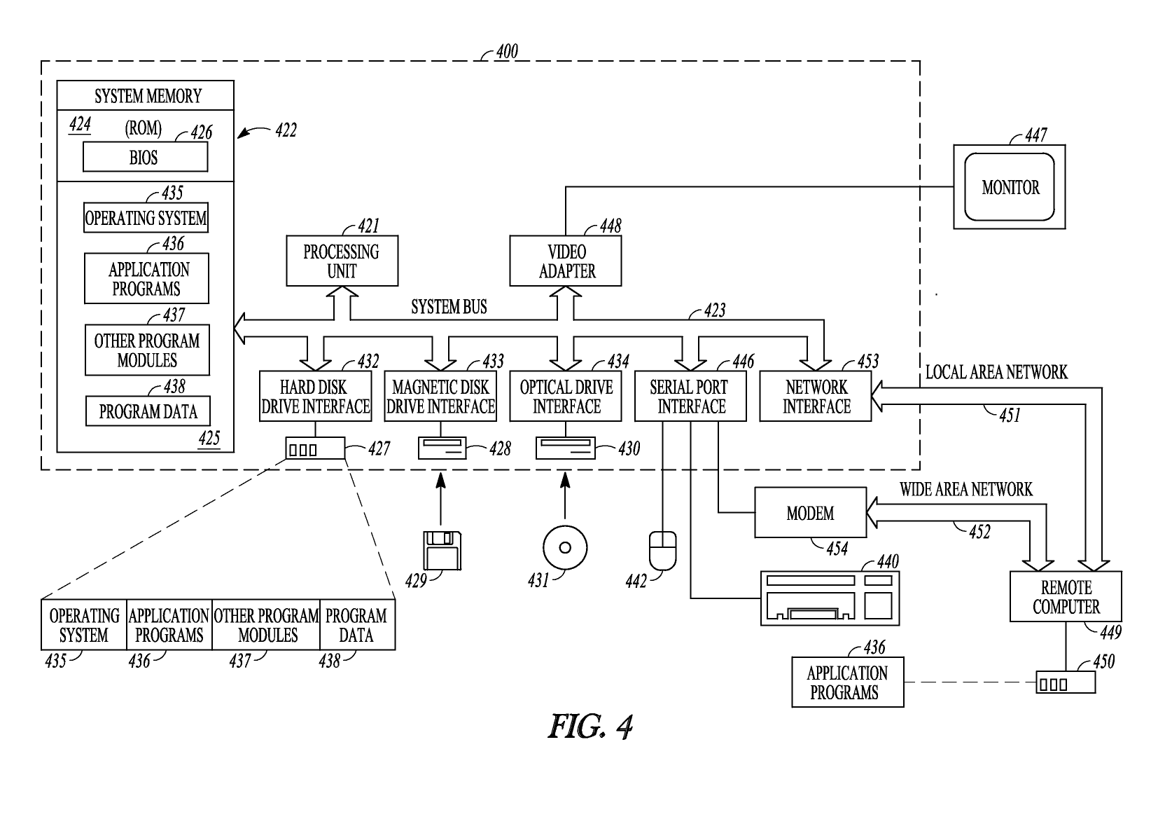

FIG. 4 is a block diagram of a computer system to implement methods and perform calculations according to an example embodiment. In the embodiment shown in FIG. 4, a hardware and operating environment is provided that is applicable to any of the servers and/or remote clients shown in the other Figures. Many of the components need not be provided to implements the functions of controller 150 in some embodiments, and in some embodiments, the minimal number of components to perform the algorithms are utilized to reduce overall cost. In further embodiments, more than one processor may be used and the functions of controller 150 may be divided between the processors or other processing circuitry. The speed of the processor should be selected as a function of the number of calculations per unit of time to perform the algorithms described.

As shown in FIG. 4, one embodiment of the hardware and operating environment includes a general purpose computing device in the form of a computer 400 (e.g., a personal computer, workstation, or server), including one or more processing units 421, a system memory 422, and a system bus 423 that operatively couples various system components including the system memory 422 to the processing unit 421. There may be only one or there may be more than one processing unit 421, such that the processor of computer 400 comprises a single central-processing unit (CPU), or a plurality of processing units, commonly referred to as a multiprocessor or parallel-processor environment. In various embodiments, computer 400 is a conventional computer, a distributed computer, or any other type of computer.

The system bus 423 can be any of several types of bus structures including a memory bus or memory controller, a peripheral bus, and a local bus using any of a variety of bus architectures. The system memory can also be referred to as simply the memory, and, in some embodiments, includes read-only memory (ROM) 424 and random-access memory (RAM) 425. A basic input/output system (BIOS) program 426, containing the basic routines that help to transfer information between elements within the computer 400, such as during start-up, may be stored in ROM 424. The computer 400 further includes a hard disk drive 427 for reading from and writing to a hard disk, not shown, a magnetic disk drive 428 for reading from or writing to a removable magnetic disk 429, and an optical disk drive 430 for reading from or writing to a removable optical disk 431 such as a CD ROM or other optical media.

The hard disk drive 427, magnetic disk drive 428, and optical disk drive 430 couple with a hard disk drive interface 432, a magnetic disk drive interface 433, and an optical disk drive interface 434, respectively. The drives and their associated computer-readable media provide non volatile storage of computer-readable instructions, data structures, program modules and other data for the computer 400. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 429, optical disk 431, ROM 424, or RAM 425, including an operating system 435, one or more application programs 436, other program modules 437, and program data 438. Programming for implementing one or more processes or method described herein may be resident on any one or number of these computer-readable media.

A user may enter commands and information into computer 400 through input devices such as a keyboard 440 and pointing device 442. Other input devices (not shown) can include a microphone, joystick, game pad, satellite dish, scanner, or the like. These other input devices are often connected to the processing unit 421 through a serial port interface 446 that is coupled to the system bus 423, but can be connected by other interfaces, such as a parallel port, game port, or a universal serial bus (USB). A monitor 447 or other type of display device can also be connected to the system bus 423 via an interface, such as a video adapter 448. The monitor 447 can display a graphical user interface for the user. In addition to the monitor 447, computers typically include other peripheral output devices (not shown), such as speakers and printers.

The computer 400 may operate in a networked environment using logical connections to one or more remote computers or servers, such as remote computer 449. These logical connections are achieved by a communication device coupled to or a part of the computer 400; the invention is not limited to a particular type of communications device. The remote computer 449 can be another computer, a server, a router, a network PC, a client, a peer device or other common network node, and typically includes many or all of the elements described above I/0 relative to the computer 400, although only a memory storage device 450 has been illustrated. The logical connections depicted in FIG. 4 include a local area network (LAN) 451 and/or a wide area network (WAN) 452. Such networking environments are commonplace in office networks, enterprise-wide computer networks, intranets and the internet, which are all types of networks.

When used in a LAN-networking environment, the computer 400 is connected to the LAN 451 through a network interface or adapter 453, which is one type of communications device. In some embodiments, when used in a WAN-networking environment, the computer 400 typically includes a modem 454 (another type of communications device) or any other type of communications device, e.g., a wireless transceiver, for establishing communications over the wide-area network 452, such as the internet. The modem 454, which may be internal or external, is connected to the system bus 423 via the serial port interface 446. In a networked environment, program modules depicted relative to the computer 400 can be stored in the remote memory storage device 450 of remote computer, or server 449. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

### Examples

1. A flame detector comprising:

a micro-optic array positioned to receive radiation from a flame;

a mid-wave infrared (MWIR) detector positioned to receive mid-wave infrared radiation from the micro-optic array; and

a controller to sequentially select different sets of pixels of the micro-optic array to provide mid-wave infrared radiation representative of the flame to the MWIR detector and provide an indication of the presence of the flame.

2. The detector of example 1 wherein the controller is configured to generate multiple sequential sparse pixel sets suitable to build a video of the source of the flame.

3. The detector of example 1 or 2 and further comprising optics positioned to focus a field of view onto the micro-optic array.

4. The detector of any of examples 1-3 wherein the controller is configured to select random patterns of mirrors for the sets of mirrors.

5. The detector of example 4 wherein the MWIR detector receives mid-wave infrared radiation from each of the mirrors in each of the sets of mirrors and provides a single aggregate intensity amplitude representative of the aggregate mid-wave infrared radiation received from each set of mirrors.

6. The detector of example 5 wherein the controller utilizes the aggregate intensity for each set of mirrors to reconstruct the image using compressive sensing optimization.

7. The detector of any of examples 1-6 wherein the mirrors of the micro-optical array are pixel elements that are switchable between transparent and opaque to the radiation.

8. The detector of any of examples 1-7 and further comprising a further detector positioned to receive radiation from at least some of the mirrors in the inverse of the selected set to provide radiation to the further detector.

9. The detector of any of examples 1-8 wherein the controller uses aggregate intensity values along with known mirrors in each set to directly determine presence of a flame without forming an image of the flame.

10. A system comprising:

a micro-optic array of pixel elements positioned to receive radiation from a flame;

a mid-wave infrared (MWIR) detector positioned to receive mid-wave infrared radiation from the micro-optic array; and

a controller to sequentially select different sets of pixel elements of the micro-optic array to provide mid-wave infrared radiation to the MWIR detector representative of the flame.

11. The system of example 10 wherein the pixel elements comprise mirrors.

12. The system of any of examples 10-11 and further comprising a further detector positioned to receive radiation from at least some of the mirrors in the inverse of the selected set to provide radiation to the further detector.

13. The system of example 12 wherein the further detector comprises an optical detector.

14. The system of any of examples 10-13 wherein the MWIR detector provides an aggregate mid-wave infrared radiation intensity value to the controller for each set of pixel elements, and wherein the controller is configured to detect the presence of the flame from the aggregate mid-wave infrared intensity values and locations of the optical elements in corresponding sets.

15. The system of example 14 wherein the controller is configured to produce an image of the flame.

16. The system of example 14 wherein the controller is configured to produce a video of the flame.

17. The system of any of examples 10-16 wherein the pixel elements comprises selectively transmissive elements.

18. A method comprising:

receiving infrared radiation from a flame at a micro-optic array of pixel elements;

positioning a MWIR detector to receive mid-wave infrared radiation from the micro-optic array; and

sequentially selecting different sets of pixel elements of the micro-optic array to provide radiation to the MWIR detector representative of the flame.

19. The method of example 18 and further comprising generating multiple sequential sparse images suitable to build a video of the source of the flame.

20. The method example 18 or 19 and further comprising filtering the received infrared radiation to pass MWIR radiation, and wherein the different sets of pixels elements are randomly selected.

21. The detector of any of examples 1-9 and further comprising a filter coupled to filter radiation to provide MWIR radiation to the detector.

22. The system of any of examples 10-16 and further comprising a filter coupled to filter radiation to provide MWIR radiation to the detector.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A flame detector comprising:
a micro-optic array positioned to receive radiation from a flame;
a mid-wave infrared (MWIR) detector positioned to receive mid-wave infrared radiation from the micro-optic array; and
a controller to sequentially select different sets of pixels of the micro-optic array to provide mid-wave infrared radiation representative of the flame to the MWIR detector and provide an indication of the presence of the flame.

2. The detector of claim 1 wherein the controller is configured to generate multiple sequential sparse pixel sets suitable to build a video of the source of the flame.

3. The detector of claim 1 and further comprising optics positioned to focus a field of view onto the micro-optic array.

4. The detector of claim 1 wherein the controller is configured to select random patterns of mirrors for the sets of mirrors.

5. The detector of claim 4 wherein the MWIR detector receives mid-wave infrared radiation from each of the mirrors in each of the sets of mirrors and provides a single aggregate intensity amplitude representative of the aggregate mid-wave infrared radiation received from each set of mirrors.

6. The detector of claim 5 wherein the controller utilizes the aggregate intensity for each set of mirrors to reconstruct the image using compressive sensing optimization.

7. The detector of claim 1 wherein the mirrors of the micro-optical array are pixel elements that are switchable between transparent and opaque to the radiation.

8. The detector of claim 1 and further comprising a further detector positioned to receive radiation from at least some of the minors in the inverse of the selected set to provide radiation to the further detector.

9. The detector of claim 1 wherein the controller uses aggregate intensity values along with known minors in each set to directly determine presence of a flame without forming an image of the flame.

10. A system comprising:
a micro-optic array of pixel elements positioned to receive radiation from a flame;
a mid-wave infrared (MWIR) detector positioned to receive mid-wave infrared radiation from the micro-optic array; and
a controller to sequentially select different sets of pixel elements of the micro-optic array to provide mid-wave infrared radiation to the MWIR detector representative of the flame.

11. The system of claim 10 wherein the pixel elements comprise mirrors.

12. The system of claim 10 and further comprising a further detector positioned to receive radiation from at least some of the minors in the inverse of the selected set to provide radiation to the further detector.

13. The system of claim 12 wherein the further detector comprises an optical detector.

14. The system of claim 10 wherein the MWIR detector provides an aggregate mid-wave infrared radiation intensity value to the controller for each set of pixel elements, and wherein the controller is configured to detect the presence of the flame from the aggregate mid-wave infrared intensity values and locations of the optical elements in corresponding sets.

15. The system of claim 14 wherein the controller is configured to produce an image of the flame.

16. The system of claim 14 wherein the controller is configured to produce a video of the flame.

17. The system of claim 10 wherein the pixel elements comprises selectively transmissive elements.

18. A method comprising:
receiving infrared radiation from a flame at a micro-optic array of pixel elements;
positioning a MWIR detector to receive mid-wave infrared radiation from the micro-optic array; and
sequentially selecting different sets of pixel elements of the micro-optic array to provide radiation to the MWIR detector representative of the flame.

19. The method of claim 18 and further comprising generating multiple sequential sparse images suitable to build a video of the source of the flame.

20. The method claim 18 and further comprising filtering the received infrared radiation to pass mid-wave infrared radiation, and wherein the different sets of pixels elements are randomly selected.
